(19) United States
(12) Patent Application Publication
(10) Pub. No.: US 2026/0057461 A1
(43) Pub. Date: Feb. 26, 2026

(54) METHOD OF DETERMINING COLLECTION PATH

(71) Applicant: TechCollect LLC, Rochester, MI (US)

(72) Inventors: Jacqueline Galofaro, Rochester Hills, MI (US); Gar Liebler, Oakland, MI (US); John Cronin, Jericho, VT (US)

(21) Appl. No.: 19/309,410

(22) Filed: Aug. 25, 2025

Related U.S. Application Data
(60) Provisional application No. 63/686,594, filed on Aug. 23, 2024.

(51) Int. Cl. G06Q 50/163; G06Q 40/12

(52) U.S. Cl. CPC G06Q 50/163; G06Q 40/12

(57) ABSTRACT

This invention describes an advanced method of assessing payment collection challenges using both artificial intelligence (AI) and machine learning (ML) techniques. The system analyzes a combination of financial data from a company's existing accounts and non-financial data to assess the likelihood of payment collections under varying conditions. It utilizes an AI model to predict collection outcomes based on historical data related to payment delays and financial hardships. The results help in tailoring collection strategies that are more effective and sensitive to the debtor's circumstances, thereby increasing the probability of recovering dues while maintaining customer relations.

### CROSS-REFERENCE TO RELATED APPLICATION

This application claims the priority benefit of U.S. provisional patent application No. 63/686,594 filed Aug. 23, 2024, which is incorporated by reference herein in their entirety.

### BACKGROUND

### Field of the Invention

The present disclosure is generally related to determining collection path.

### Description of the Related Art

Currently, without leveraging non-financial data, property managers struggle to predict which occupants are more likely to encounter difficulties in paying rent or home owners association (HOA) fees on time, leading to reactive rather than proactive collection strategies. Property management teams may waste time and resources pursuing rent collection from occupants who are ultimately unable or unwilling to pay, diverting attention from more promising collection opportunities. Also, failing to consider non-financial indicators of occupant reliability increases the risk of occupant defaults and late payments, impacting cash flow and overall financial stability for property owners and management companies. Without insights into occupants' communication preferences and responsiveness, property managers may struggle to engage with occupants effectively, leading to missed payment reminders and late responses to collection efforts. Lastly, in the absence of comprehensive patron 134 profiles that include non-financial data, property managers may struggle to identify and address underlying issues that contribute to patron 134 dissatisfaction and turnover, impacting long-term patron 134 retention rates. Property managers may lack the ability to differentiate between occupants with a history of timely payments and those who are more likely to default, leading to missed opportunities to mitigate risk and implement targeted intervention strategies. Thus, there is a need in the prior art to determine the ease of collection of a payment.

### SUMMARY OF THE CLAIMED INVENTION

Embodiments of the present invention may include a method and a non-transitory computer-readable storage medium having embodied thereon a program executable by a processor to perform a method for determining collection path. The method includes storing a plurality of tiers and one or more rules associated with each tier, receiving data of a user account over a communication network, extracting one or more features from the received data, wherein the features are associated with threshold conditions, analyzing the features using a machine learning model to determine likelihood of a payment event associated with the user account and a tier associated with the user account, and executing an action based on the tier associated with the user account.

Embodiments of the present invention further includes a system for determining collection path. The system includes memory that stores a plurality of tiers and one or more rules associated with each tier, a communication interface that communicates over a communication network to receive data of a user account, and a processor that executes instructions stored in memory, wherein the processor executes the instructions to extract one or more features from the received data, wherein the features are associated with threshold conditions, analyze the features using a machine learning model to determine likelihood of a payment event associated with the user account and a tier associated with the user account, and execute an action based on the tier associated with the user account.

### DESCRIPTIONS OF THE DRAWINGS

FIG. 1: Illustrates a determining ease of collection of a payment, according to an embodiment.

FIG. 2: Illustrates a Base Module, according to an embodiment.

FIG. 3: Illustrates a Payment Analysis Module, according to an embodiment.

FIG. 4: Illustrates a Profile Module, according to an embodiment.

FIG. 5: Illustrates an Action Module, according to an embodiment.

FIG. 6: Illustrates a Feedback Module, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

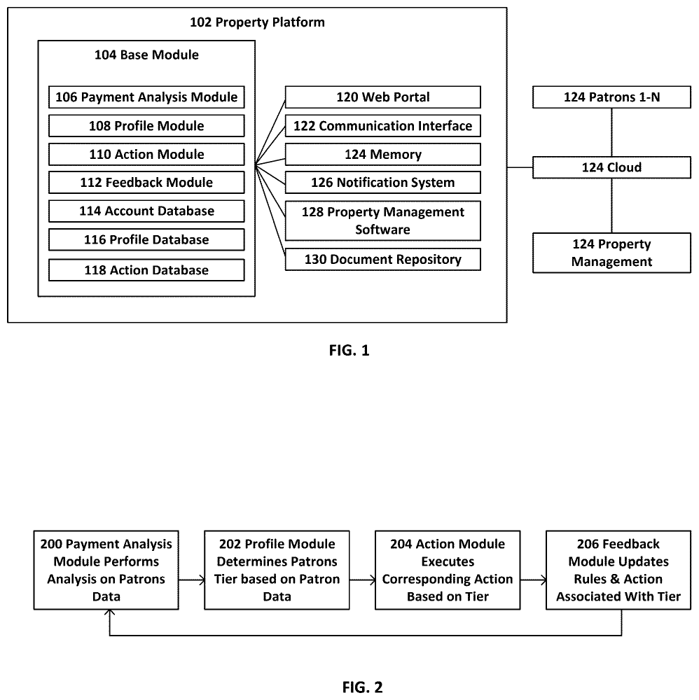

FIG. 1 illustrates a method for determining the ease of collection of a payment. This method comprises a property platform 102 that utilizes a payment analysis module 106 to analyze payment behaviors across a group of patrons 134, examining factors like payment histories and outstanding balances. The property platform 102 employs a profile module 108 that considers non-financial data associated with each patron 134, such as communication responsiveness and interaction history, to gauge their likelihood of cooperation. Based on this analysis, the property platform 102 generates individual collection profiles for patrons 134, which inform tailored collection actions. These actions may range from gentle reminders to more assertive measures and are executed to optimize payment collection while nurturing positive relationships with patrons 134.

Further, embodiments may include a base module 104, which initiates the payment analysis module 106, profile module 108, action module 110, and feedback module 112.

Further, embodiments may include a payment analysis module 106, which begins by being initiated by the base module 104. The payment analysis module 106 filters the account database 114 on the first patron 134. The payment analysis module 106 extracts the patron's 134 financial data from the account database 114. The payment analysis module 106 performs the payment analysis on the patron's 134 financial data. The payment analysis module 106 determines if the patron's 134 payments are delinquent. If it is determined that the patron's 134 payments are delinquent, the payment analysis module 106 stores the patron's 134 data in the profile database 116. If it is determined that the patron's 134 payments are not delinquent or after the patron's 134 data is stored in the profile database 116, the payment analysis module 106 determines if there are more patrons 134 remaining in the account database 114. If it is determined that there are more patrons 134 remaining in the account database 114, the payment analysis module 106 filters the account database 114 on the next patron 134, and the process returns to extracting the patron's 134 financial data from the account database 114. If it is determined that there are no more patrons 134 remaining in the account database 114, the payment analysis module 106 returns to the base module 104.

Further, embodiments may include a profile module 108, which begins by being initiated by the base module 104. The profile module 108 extracts the first patron 134 data from the profile database 116. The profile module 108 sends a notification to the patron 134. The profile module 108 determines if patron 134 opted into a potential hardship payment adjustment. If it is determined that the patron 134 did not opt-in to a potential hardship payment adjustment, the profile module 108 removes the patron 134 from the profile database 116. If it is determined that the patron 134 did opt-in to a potential hardship payment adjustment the profile module 108 receives additional non-financial data from the patron 134. The profile module 108 determines the patron collection profile of the patron 134. The profile module 108 stores the patron collection profile in the profile database 116. The profile module 108 determines if there are more patrons than 134 remaining in the profile database 116. If it is determined that there are more patrons 134 remaining in the profile database 116, the profile module 108 extracts the next patron data from the profile database 116, and the process returns to determining the patron collection profile of the patron 134. If it is determined that there are no more patrons 134 remaining in the profile database 116, the profile module 108 returns to the base module 104.

Further, embodiments may include an action module 110, which begins by being initiated by the base module 104. The action module 110 extracts the first patron profile from the profile database 116. The action module 110 compares the extracted data to the action database 118. The action module 110 determines if there is a corresponding action in the action database 118. If it is determined that there is a corresponding action in the action database 118, the action module 110 extracts the corresponding action from the action database 118. The action module 110 executes the corresponding action extracted from the action database 118. If it is determined that there is no corresponding action or after the extracted action has been executed, the action module 110 determines if there are more patron profiles stored in the profile database 116. If it is determined that there are more patron profiles stored in the profile database 116, the action module 110 extracts the next patron profile from the profile database 116 and the process returns to comparing the patron profile to the action database 118. If it is determined that no more patron profiles are remaining in the profile database 116 the action module 110 returns to the base module 104.

Further, embodiments may include a feedback module 112, which begins by being initiated by the base module 104. The feedback module may run continuously or initiated by an event, such as a change in the patrons data or changes to regulations. The feedback module 112 filters the account database 114 on patrons 134 with hardship payment plans. The feedback module 112 filters the account database 114 on patrons 134 in tier one of the hardship payment plan. The feedback module 112 analyzes the payment history of the patrons 134, communication disposition of the patrons, letters returned, disputes engaged by the patrons, and statute changes that affect the patrons policies in the tier. The feedback module 112 determines if the tier rule should be updated. If it is determined that the tier rule should be updated the feedback module 112 updates the rule and action associated with the tier. The feedback module 112 stores the updated rule in the action database 118. If it is determined that the tier rule should not be updated or after the updated tier rule is stored in the action database 118, the feedback module 112 determines if there are more tiers remaining in the account database 114. If it is determined that there are more tiers remaining in the account database 114, the feedback module 112 filters the account database 114 on patrons in the next tier, and the process returns to analyzing the payment history. If it is determined that there are no more tiers remaining in the account database 114, the feedback module 112 returns to the base module 104.

Further, embodiments may include an account database 114, which may be a database stored in the document repository 130 in which the patrons 134 data is collected through the property management software 128. The account database 114 may contain the patron's 134 information, such as the patron ID, first name, last name, address, home equity, the estimated value of the home, the patron's payment history stored as a data file, if the patron has hardship payments and the hardship tier the patron is in. In some embodiments, the account database 114 may contain the patron's 134 city, state, zip code, number of adults, number of children, education level, disposable income, liquid assets, income, patron's 134 middle initial, phone number, political party affiliation, if the patron 134 responds to emails, phone calls, or texts, the patron's 134 email address, social media avatars, social media profiles, such as LinkedIn, Facebook, Instagram, etc., if the patron 134 owns an RV, the number of vehicles, age, family size, years of employment, debt range, debt utilization, etc.

Further, embodiments may include a profile database 116, which is created during the process described in the payment analysis module 106 and the profile module 108 in which the patron data stored in the account database 114 is stored and the patron 134 opts-in to have a potential hardship situation reviewed and sends additional non-financial data which is also stored in the profile database 116. The profile database 116 may contain the patron's 134 ID, first name, last name, address, number of adults, number of children, education level, the potential hardship, such as financial, personal, legal, natural disaster, property issue, etc. In some embodiments, the profile database 116 may contain the patron's 134 rental history, employment history, timeliness of payments, remaining term on the payment plan, complaints, communication with property managers, renewal statuses, property condition, updating personal contact information, patron's 134 providing feedback, maintenance visits, damages or neglect of the property by the patron 134, parking violations, pet violations, etc. The profile database 116 may be used to compare the patron's 134 non-financial data, either previously collected and stored in the account database 114 or the newly received and stored data, to determine if the patron 134 is currently experiencing hardship and if the payment plan the patron 134 is currently on should be adjusted or not.

Further, embodiments may include an action database 118, which may be a previously created or existing database that contains a plurality of rules that are used in the action module 110 to determine if there is a corresponding action or notification that needs to be sent to a patron 134. The action database 118 may contain a hardship tier, the type of hardship, the rule, and the corresponding action. In some embodiments, the rules may be generic rules based on the total profile of the patron's 134 collection profile. In some embodiments, the rules may be based on the tier and type of hardship that the patron 134 is experiencing, or there may be multiple types of hardship situations in multiple different tiers. In some embodiments, the rules may ease the collection of payments made by the patron 134 to provide financial flexibility depending on the patron's 134 current situation. In some embodiments, the corresponding actions may range from extending the payment plan to waiving the payments required by the patron 134. For example, if patron 134 is facing financial hardship, such as loss of employment, the corresponding action may be to offer temporary payment deferrals or reduced payment plans until the member secures new employment. If patron 134 is experiencing difficulties from a natural disaster, such as flooding, the corresponding action may be to offer temporary relief by allowing affected members to delay payments or reduce payment amounts temporarily while they repair their property. If the patron is experiencing a serious illness, such as terminal cancer, then the corresponding action may waive the remaining payments of the patron 134. If patron 134 is facing legal issues, such as a lawsuit settlement, the corresponding action may be to arrange a payment plan tailored to patron's 134 financial situation after a lawsuit settlement to ensure they can fulfill their HOA obligations. If patron 134 is experiencing property issues, such as plumbing issues, the corresponding action may be for the property management software 128 to contact maintenance to address the plumbing issue and remove the late fees from the patron's 134 account

Further, embodiments may include a web portal 120, which may be a web-based application or website that serves as a single point of access for users to access information, services, and resources. The web portal 120 may allow patrons 134 to securely log in and access features such as rent payment, communication with property management 136, maintenance request submission, access to documents, community forums, and other relevant functionalities. The web portal 120 may be designed for property management and may consist of various components and features integrated into a cohesive interface accessible via a web browser. In some embodiments, the web portal 120 may include user authentication that requires users, such as patrons 134, to authenticate themselves through secure login credentials, for example, username, password, multi-factor authentication, etc. In some embodiments, the web portal 120 may include a dashboard, which may display relevant information such as upcoming rent payments, maintenance request status, announcements, and notifications. In some embodiments, the web portal 120 may include a rent payment module, which may be a dedicated section that allows patrons 134 to view their rent balance, make payments using various methods, such as credit/debit cards, ACH transfers, etc., set up recurring payments, view payment history and generate receipts. In some embodiments, the web portal 120 may include a communication hub, which enables direct messaging between patrons 134 and property management 136 staff for inquiries, complaints, or general communication and may support sending announcements, alerts, and updates to all patrons 134. In some embodiments, the web portal 120 may include a complaint management system, which allows patrons 134 to submit maintenance requests or complaints through a user-friendly interface, tracks the status of requests, assigns tasks to maintenance staff, and provides updates to patrons. In some embodiments, the web portal 120 may include property updates and notifications by displaying announcements, news, and updates regarding the property, community events, maintenance schedules, etc., through push notifications or email alerts to patrons 134 for important developments. In some embodiments, the web portal 120 may include patron 134 feedback and survey forms for patrons 134 to provide input on their living experience and suggest improvements. In some embodiments, the web portal 120 may include account management, which allows patrons 134 to manage their profiles, update personal information, view transaction history, and provide a log of past interactions and activities within the portal. In some embodiments, the web portal 120 may be integrated with the property management software 128 to synchronize data, streamline administrative processes, and ensure real-time updates and data consistency across systems.

Further, embodiments may include a communication interface 122, which may be a hardware or software component that enables communication between two or more electronic devices or systems. The communication interface 122 may include a set of protocols, rules, and standards that define how information is transmitted and received between the devices. The communication interface 122 may be a physical connector, wireless network, or software application and may include components such as drivers, software libraries, and firmware that may be used to control and manage the communication process. In some embodiments, the communication interface 122 may be compatible with USB, Bluetooth, or Wi-Fi. The communication interface 122 may communicate with a network. Examples of networks may include, but are not limited to, the Internet, a cloud network, a Wireless Fidelity (Wi-Fi) network, a Wireless Local Area Network (WLAN), a Local Area Network (LAN), a telephone line (POTS), Long Term Evolution (LTE), and/or a Metropolitan Area Network (MAN).

Further, embodiments may include a memory 124, which may include suitable logic, circuitry, and/or interfaces that may be configured to store a machine code and/or a computer program with at least one code section executable by the processor. Examples of implementation of the memory 124 may include, but are not limited to, Random Access Memory (RAM), Read Only Memory (ROM), Hard Disk Drive (HDD), and/or a Secure Digital (SD) card.

Further, embodiments may include a notification system 126, which may be a software component or service that enables the generation, management, and delivery of notifications to users based on specific triggers or events within an application or system. The notification system 126 may handle the dissemination of various types of notifications, such as rent payment reminders, maintenance request updates, announcements, and emergency alerts, to patrons 134 and property management 136 personnel through multiple communication channels. The notification system 126 may be designed to ensure effective communication and timely dissemination of information to relevant stakeholders. In some embodiments, the notification system 126 may be configured to monitor specific events or triggers within the property platform 102, such as rent due dates, maintenance request submissions, or new announcements. In some embodiments, the notification system 126 may generate the corresponding notification based on predefined templates and rules, including text messages, emails, push notifications to mobile devices, or in-app alerts. In some embodiments, the notification system 126 may determine the recipients of each notification based on predefined criteria, such as the patrons 134 associated with a particular property, property management 136 staff responsible for handling maintenance requests, or all patrons 134 within a specific community. In some embodiments, the notification system 126 may select the appropriate delivery channels for each notification, including email, SMS/text messaging, mobile app push notifications, and in-app alerts. In some embodiments, the notification system 126 may allow notifications to be personalized with relevant details, such as the patron's 134 name, property address, or specific information related to the event triggering the notification. In some embodiments, the notification system 126 may allow for the scheduling of notifications to be sent at specific times or intervals, ensuring that they reach recipients at appropriate times. In some embodiments, real-time notifications may also be triggered immediately upon the occurrence of time-sensitive events, such as emergency alerts or critical updates. In some embodiments, the notification system 126 may track the delivery status of each notification, including successful deliveries, failures, and recipient responses. In some embodiments, the notification system 126 may seamlessly integrate with the property platform 102, enabling it to access relevant data and trigger notifications based on real-time events and updates within the system.

Further, embodiments may include property management software 128, which may be a cloud-based or on-premise software application that facilitates the management of residential or commercial properties by automating processes such as patron 134 screening, lease/HOA management, rent/fee collection, maintenance tracking, and financial reporting. The property management software 128 may serve as a centralized platform for property management 136, landlords, and patrons 134 to manage and access property-related information and perform various tasks. In some embodiments, the property management software 128 may store patron 134 information, including contact details, lease/HOA agreements, rental history, and payment records. In some embodiments, the property management software 128 may allow property management 136 to easily add, edit, or terminate patron agreements and provides tools for patron 134 screening and background checks during the application process. In some embodiments, the property management software 128 may manage agreements, including terms, renewal dates, rental rates, HOA fees, and security deposits. In some embodiments, the property management software 128 may facilitate rent collection through various payment methods, including online payments, ACH transfers, and credit card processing. In some embodiments, the property management software 128 may track rent payments, late fees, and outstanding balances. In some embodiments, the property management software 128 may generate financial reports, such as income statements, balance sheets, and rent roll summaries. In some embodiments, the property management software 128 may log maintenance requests submitted by patrons and track their status from submission to completion. In some embodiments, the property management software 128 may store and organize property-related documents, such as lease/HOA agreements, inspection reports, insurance policies, and patron 134 communications.

Further, embodiments may include a document repository 130, which may be a software component or service within a property platform 102 that provides a centralized location for storing, managing, and accessing property-related documents and files. The document repository 130 may be a database or file system to securely store documents, along with metadata and indexing capabilities for efficient organization and retrieval. The document repository 130 may support features such as document upload, version control, access control, search functionality, and integration with other modules of the property management platform. The document repository 130 may be a digital archive for storing and managing a wide range of property-related documents and files.

Further, embodiments may include a cloud 132 or a communication network, which may be a wired and/or wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet, and relies on the sharing of resources to achieve coherence and economies of scale, like a public utility, while third-party clouds enable organizations to focus on their core businesses instead of expending resources on computer infrastructure and maintenance. The property platform 102 and the components of the property platform 102, such as web portal 120, may communicate with the patrons 134 and the property management software 136 via the cloud 132.

Further, embodiments may include a plurality of patrons 134, who may be members of a homeowners association, or HOA, that are the individuals who own property within the community governed by the association. They are bound by the rules, regulations, and financial obligations set forth by the HOA's governing documents, which usually include articles of incorporation, bylaws, covenants, conditions, and restrictions. In some embodiments, the patrons 134 may have voting rights and may participate in HOA meetings and decision-making processes. Patrons 134 may be responsible for paying HOA fees and adhering to the community's rules and regulations. In some embodiments, the plurality of patrons 134 may refer to entities associated with rental agreements for residential or commercial properties. Patrons 134 may be represented as records within the software's database and are characterized by attributes such as personal information, lease/HOA terms, rental history, payment records, and contact details. The property platform 102 enables property management 136 to manage patron 134 information, track lease/HOA agreements, monitor rent/HOA payments, communicate with patron 134, and address maintenance requests and issues.

Further, embodiments may include property management 136, who may be individuals or entities responsible for the day-to-day operations, financial management, patron 134 relations, and maintenance of rental properties. Property management 136 may involve tasks such as lease/HOA management, rent/fee collection, maintenance coordination, patron screening, property marketing, and financial reporting. In some embodiments, property managers may utilize the property platform 102 to streamline workflows, automate processes, and efficiently manage various aspects of property management.

FIG. 2 illustrates the base module 104. The process begins with the base module initiating, at step 200, the payment analysis module 106. For example, the payment analysis module 106 begins by being initiated by the base module 104. The payment analysis module 106 filters the account database 114 on the first patron 134. The payment analysis module 106 extracts the patron's 134 financial data from the account database 114. The payment analysis module 106 performs the payment analysis on the patron's 134 financial data. The payment analysis module 106 determines if the patron's 134 payments are delinquent. If it is determined that the patron's 134 payments are delinquent, the payment analysis module 106 stores the patron's 134 data in the profile database 116. If it is determined that the patron's 134 payments are not delinquent or after the patron's 134 data is stored in the profile database 116, the payment analysis module 106 determines if there are more patrons 134 remaining in the account database 114. If it is determined that there are more patrons 134 remaining in the account database 114, the payment analysis module 106 filters the account database 114 on the next patron 134, and the process returns to extracting the patron's 134 financial data from the account database 114. If it is determined that there are no more patrons 134 remaining in the account database 114, the payment analysis module 106 returns to the base module 104. The base module 104 initiates, at step 202, the profile module 108. For example, the profile module 108 begins by being initiated by the base module 104. The profile module 108 extracts the first patron 134 data from the profile database 116. The profile module 108 sends a notification to the patron 134. The profile module 108 determines if patron 134 opted into a potential hardship payment adjustment. If it is determined that the patron 134 did not opt-in to a potential hardship payment adjustment, the profile module 108 removes the patron 134 from the profile database 116. If it is determined that the patron 134 did opt-in to a potential hardship payment adjustment the profile module 108 receives additional non-financial data from the patron 134. The profile module 108 determines the patron collection profile of the patron 134. The profile module 108 stores the patron collection profile in the profile database 116. The profile module 108 determines if there are more patrons 134 remaining in the profile database 116. If it is determined that there are more patrons 134 remaining in the profile database 116, the profile module 108 extracts the next patron data from the profile database 116, and the process returns to determining the patron collection profile of the patron 134. If it is determined that there are no more patrons 134 remaining in the profile database 116, the profile module 108 returns to the base module 104.

The base module 104 initiates, at step 204, the action module 110. For example, the action module 110 begins by being initiated by the base module 104. The action module 110 extracts the first patron profile from the profile database 116. The action module 110 compares the extracted data to the action database 118. The action module 110 determines if there is a corresponding action in the action database 118. If it is determined that there is a corresponding action in the action database 118, the action module 110 extracts the corresponding action from the action database 118. The action module 110 executes the corresponding action extracted from the action database 118. If it is determined that there is no corresponding action or after the extracted action has been executed, the action module 110 determines if there are more patron profiles stored in the profile database 116. If it is determined that there are more patron profiles stored in the profile database 116, the action module 110 extracts the next patron profile from the profile database 116, and the process returns to comparing the patron profile to the action database 118. If it is determined that no more patron profiles are remaining in the profile database 116 the action module 110 returns to the base module 104.

The base module 104 initiates, at step 206, the feedback module 112. For example, the feedback module 112 begins by being initiated by the base module 104. The feedback module 112 filters the account database 114 on patrons 134 with hardship payment plans. The feedback module 112 filters the account database 114 on patrons 134 in tier one of the hardship payment plan. The feedback module 112 analyzes the payment history of the patrons 134 in the tier. The feedback module 112 determines if the tier rule should be updated. If it is determined that the tier rule should be updated the feedback module 112 updates the rule and action associated with the tier. The feedback module 112 stores the updated rule in the action database 118. If it is determined that the tier rule should not be updated or after the updated tier rule is stored in the action database 118, the feedback module 112 determines if there are more tiers remaining in the account database 114. If it is determined that there are more tiers remaining in the account database 114, the feedback module 112 filters the account database 114 on patrons in the next tier, and the process returns to analyzing the payment history. If it is determined that there are no more tiers remaining in the account database 114, the feedback module 112 returns to the base module 104.

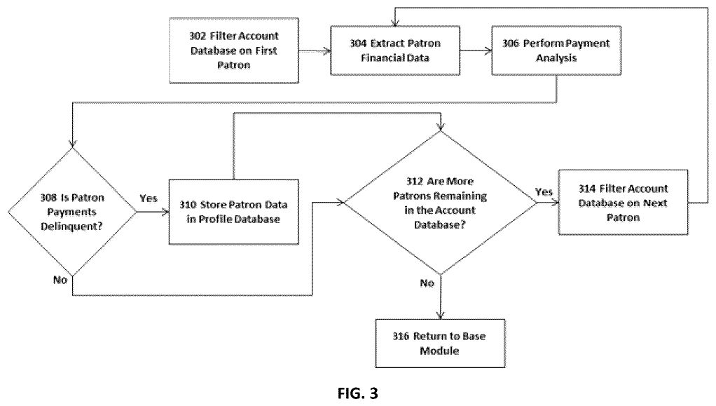

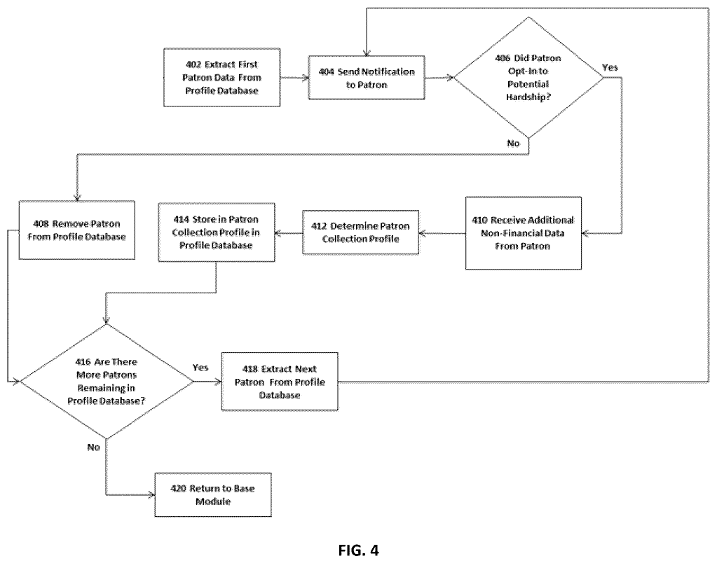

FIG. 3 illustrates the payment analysis module 106. The process begins with the payment analysis module 106 being initiated by the base module 104. The payment analysis module 106 filters, at step 302, the account database 114 on the first patron 134. The payment analysis module 106 may filter the account database 114 on the first patron's 134 ID. The payment analysis module 106 extracts, at step 304, the patron's 134 financial data from the account database 114. The payment analysis module 106 extracts the patron's 134 financial data, such as the patron's 134 payment history data file, from the account database 114. In some embodiments, the payment analysis module 106 may extract the patron's 134 information, such as the patron ID, first name, last name, address, home equity, the estimated value of the home, the patron's payment history stored as a data file, if the patron has hardship payments, and the hardship tier the patron is in. In some embodiments, the account database 114 may contain the patron's 134 city, state, zip code, number of adults, number of children, education level, disposable income, liquid assets, income, patron's 134 middle initial, phone number, political party affiliation, if the patron 134 responds to emails, phone calls, or texts, the patron's 134 email address, social media avatars, social media profiles, such as LinkedIn, Facebook, Instagram, etc., if the patron 134 owns an RV, the number of vehicles, age, family size, years of employment, debt range, debt utilization, etc. The payment analysis module 106 performs, at step 306, the payment analysis on the patron's 134 financial data. For example, the payment analysis may be an algorithm that evaluates if a patron's 134 account is in delinquency status or not. The payment analysis may utilize variables from the account database 114, including the payment history data file, which may include total payments and last payment date. It may iterate through the payment history records to calculate the aggregate sum of payments, accumulating in total payments. The payment analysis then compares the date of the last recorded payment with the current date to determine if it surpasses the agreed-upon payment interval. If the elapsed time exceeds said interval, the account is marked as potentially delinquent due to a recent payment lapse. Further, the payment analysis may compare the total payments against the amount owed for the corresponding period. Should the former fall short of the latter, indicating underpayment, the account is designated as delinquent. The payment analysis may flag or mark the account for additional scrutiny or action if deemed delinquent or designate it as current if payments are deemed current. The payment analysis module 106 determines, at step 308, if the patron's 134 payments are delinquent. If the payment analysis performed flags or marks the patron's 134 account as delinquent the payment analysis module 106 can determine that the patron's 134 payments are delinquent. If it is determined that the patron's 134 payments are delinquent, the payment analysis module 106 stores, at step 310, the patron's 134 data in the profile database 116. In some embodiments, the payment analysis module 106 may store the patron's 134 data in the profile database 116, such as the patron's 134 ID, first name, last name, address, number of adults, number of children, education level, etc. In some embodiments, the data stored in the profile database 116 may include the patron's 134 city, state, zip code, patron's 134 middle initial, phone number, and political party affiliation, if the patron 134 responds to emails, phone calls, or texts, the patron's 134 email address, social media avatars, social media profiles, such as LinkedIn, Facebook, Instagram, etc., if the patron 134 owns an RV, the number of vehicles, age, family size, years of employment, etc. if it is determined that the patron's 134 payments are not delinquent or after the patron's 134 data is stored in the profile database 116 the payment analysis module 106 determines, at step 312, if there are more patrons 134 remaining in the account database 114. If it is determined that there are more patrons 134 remaining in the account database 114, the payment analysis module 106 filters, at step 314, the account database 114 on the next patron 134, and the process returns to extracting the patron's 134 financial data from the account database 114. If it is determined that there are no more patrons 134 remaining in the account database 114, the payment analysis module 106 returns, at step 316, to the base module 104.

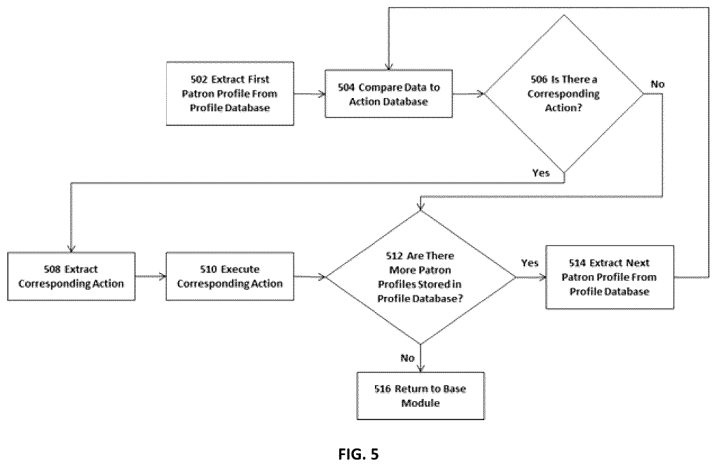

FIG. 4 illustrates the profile module 108. The process begins with the profile module 108 being initiated by the base module 104. The profile module 108 extracts, at step 402, the first patron 134 data from the profile database 116. The profile module 108 may extract the first patron 134 data, such as the patron's 134 ID, first name, last name, address, number of adults, number of children, education level, etc. In some embodiments, the data stored in the profile database 116 may include the patron's 134 city, state, zip code, patron's 134 middle initial, phone number, and political party affiliation. If the patron 134 responds to emails, phone calls, or texts, the patron's 134 email address, social media avatars, social media profiles, such as LinkedIn, Facebook, Instagram, etc., if the patron 134 owns an RV, the number of vehicles, age, family size, years of employment, etc. The profile module 108 sends, at step 404, a notification to the patron 134. The notification may be sent to the patron 134 through text, email, etc. The notification may be sent through the web portal 120 to inform patron 134 that they may qualify for a hardship repayment adjustment.

The profile module 108 determines, at step 406, if patron 134 opted into a potential hardship payment adjustment. Patron 134 may opt-in for a potential hardship payment adjustment by responding to the notification sent by profile module 108. The patron 134 may respond through a text, email, through the web portal 120, etc. If it is determined that the patron 134 did not opt-in to a potential hardship payment adjustment, the profile module 108 removes, at step 408, the patron 134 from the profile database 116. The profile module 108 may delete the data entry associated with patron 134 if patron 134 did not opt in or declined to opt in for a hardship repayment plan. If it is determined that patron 134 did opt-in to a potential hardship payment adjustment the profile module 108 receives, at step 410, additional non-financial data from patron 134. For example, if the patron 134 opted into a hardship repayment plan, the patron 134 may be requested to send additional information related to a potential hardship, such as a financial, personal, legal, natural disaster, or property issue hardship. The patron 134 may be required to send additional non-financial data that relates to the type of hardship they are potentially facing or experiencing, such as documents related to the decrease in income, death in the family, natural disaster damages, property damages, or issues, etc. In some embodiments, if the patron 134 opted-in through the web portal, the patron 134 may be requested to answer a series of prompts to collect the non-financial data that is related to their unique hardship, and the patron 134 may upload supporting documents through the web portal 120.

The profile module 108 determines, at step 412, the patron collection profile of the patron 134. For example, the patron 134 collection profile may use a rating system that determines the tier in which the patron is placed depending on the hardship they are currently experiencing. A tier 1 rating may indicate a property issue hardship or a withhold of payment due to property issues that the property management 136 should address, and a tier 5 rating may indicate a more serious hardship, such as the patron 134 having damages to the property due to a natural disaster, including hurricanes or flooding. The profile module 108 may use the non-financial data collected from patron 134 to determine which tier they belong in. Tier 1 may be property issues, tier 2 may be financial hardships, tier 3 may be personal hardships, tier 4 may be legal hardships, and tier 5 may be natural disaster hardships. In some embodiments, the patron 134 may select on the web portal 120 which type of hardship they are currently experiencing and provide proof of that hardship through uploading or sending additional documents so they can grouped into the correct tier. In some embodiments, machine learning techniques may be utilized to analyze historical data and predict future payment behavior. For example, the process may involve data collection and preprocessing through the property management software 128 collecting a diverse range of patron 134 related data, including number of adults, number of children, age, education level, city, state, zip code, patron's 134 middle initial, phone number, political party affiliation, if the patron 134 responds to emails, phone calls, or texts, the patron's 134 email address, social media avatars, social media profiles, such as LinkedIn, Facebook, Instagram, etc., if the patron 134 owns an RV, the number of vehicles, age, family size, years of employment, type of property associated with the patron, information related to the patron's payment plan (e.g., payment plan status, payment history), the associated rules or regulations that affect the property, the payment plan, or the patron (e.g., HOA cadence rules, statutory windows), etc. The historical data may be sourced from Homeowners Association (HOA) ledgers, digital exhaust that includes communication data and metadata generated as a byproduct of digital interactions such as email, SMS, telephonic calls, letters, etc., payment gateways, property/association rules servers or databases, and dispute logs. The historical data may be received from communicating with a plurality of third party servers via a communication network. The received data may be filtered and curated based on the completeness and accuracy of the data, as well as the time period the data was recorded, geographical area, and grouped based on similarity of the patrons. The received data may filter out outliers.

This data is cleaned, transformed, and prepared for analysis, ensuring consistency and accuracy across different sources. Then, the machine learning algorithm may be trained using historical data to identify patterns and relationships between various features and the likelihood of on-time payments. Supervised learning algorithms, such as classification or regression models, may be utilized to predict patrons' 134 payment behavior based on their attributes and historical performance. Features such as payment history, employment stability, timeliness of past payments, and payment terms may be used as inputs to the model, while the target variable is whether the patron 134 paid on time. The predicted payment behavior may include how likely a payment event is and when the payment event may occur. The model may continuously be updated and retrained based on received data regarding a new patron accounts or changes or updates in the data regarding previous patron accounts. The triggers for retraining may include exceeding one or more thresholds for feature drift, such as population stability index greater than 0.25, key performance indicator degradation beyond threshold, statue/policy changes, or calibration staleness. Newly received patron data after the model is trained, as well as the prediction regarding the payment event or an actual payment event may be used to further train the machine learning model.

Once the model is trained, it may undergo validation and testing to assess its performance and generalization ability. In some embodiments, cross-validation techniques and performance metrics such as accuracy, precision, recall, and F1-score may be used to evaluate the model's effectiveness in predicting patrons' 134 payment behavior. The model's performance may be validated through a separate dataset to ensure that it can generalize well to new, unseen data. The profile module 108 stores, at step 414, the patron 134 collection profile in the profile database 116. The profile module 108 may include the type of hardship the patron 134 is currently experiencing.

The profile module 108 determines, at step 416, if there are more patrons 134 remaining in the profile database 116. The profile module 108 may perform the patron 134 collection profile for each patron 134 stored in the profile database 116. If it is determined that there are more patrons 134 remaining in the profile database 116, the profile module 108 extracts, at step 418, the next patron data from the profile database 116, and the process returns to determining the patron 134 collection profile of the patron 134. If it is determined that there are no more patrons 134 remaining in the profile database 116, the profile module 108 returns, at step 420, to the base module 104.

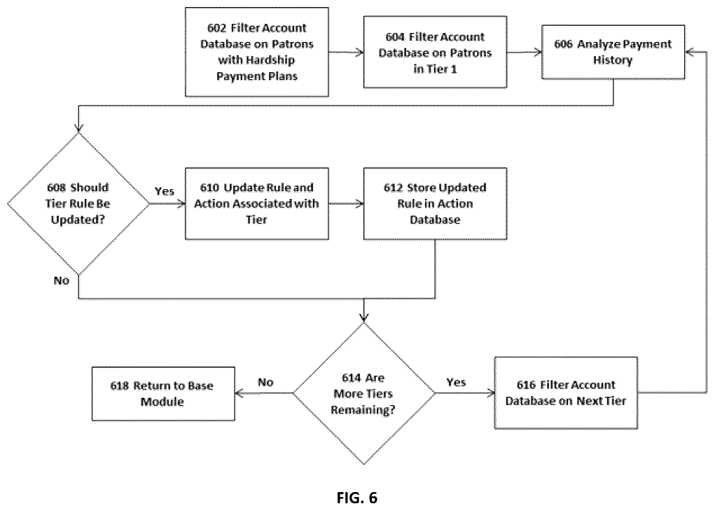

FIG. 5 illustrates the action module 110. The process begins with the action module 110 being initiated by the base module 104. The action module 110 extracts, at step 502, the first patron profile from the profile database 116. The profile database 116 may contain the patron's 134 ID, first name, last name, address, number of adults, number of children, education level, the potential hardship, such as financial, personal, legal, natural disaster, property issue, etc. In some embodiments, the profile database 116 may contain the patron's 134 rental history, employment history, timeliness of payments, remaining term on the payment plan, complaints, communication with property managers, renewal statuses, property condition, updating personal contact information, patron's 134 providing feedback, maintenance visits, damages or neglect of the property by the patron 134, parking violations, pet violations, etc. The action module 110 compares, at step 504, the extracted data to the action database 118. The action module 110 compares the patron 134 profile data extracted from the profile database 116 to the action database 118 to determine if there is a corresponding action that needs to be extracted and executed. The action database 118 may be a previously created or existing database that contains a plurality of rules that are used in the action module 110 to determine if there is a corresponding action or notification that needs to be sent to a patron 134. The action database 118 may contain a hardship tier, the type of hardship, the rule, and the corresponding action. The action module 110 determines, at step 506, if there is a corresponding action in the action database 118. For example, the rules may be generic rules based on the total profile of the patron's 134 collection profile. In some embodiments, the rules may be based on the tier and type of hardship that the patron 134 is experiencing, or there may be multiple types of hardship situations in multiple different tiers. In some embodiments, the rules may ease the collection of payments made by the patron 134 to provide financial flexibility depending on the patron's 134 current situation. In some embodiments, the corresponding actions may range from extending the payment plan to waiving the payments required by the patron 134. For example, if patron 134 is facing financial hardship, such as loss of employment, the corresponding action may be to offer temporary payment deferrals or reduced payment plans until the member secures new employment. If patron 134 is experiencing difficulties from a natural disaster, such as flooding, the corresponding action may be to offer temporary relief by allowing affected members to delay payments or reduce payment amounts temporarily while they repair their property. If the patron is experiencing a serious illness, such as terminal cancer, then the corresponding action may waive the remaining payments of the patron 134. If patron 134 is facing legal issues, such as a lawsuit settlement, the corresponding action may be to arrange a payment plan tailored to patron's 134 financial situation after a lawsuit settlement to ensure they can fulfill their HOA obligations. If patron 134 is experiencing property issues, such as plumbing issues, the corresponding action may be for the property management software 128 to contact maintenance to address the plumbing issue and remove the late fees from the patron's 134 account. If it is determined that there is a corresponding action in the action database 118, the action module 110 extracts, at step 508, the corresponding action from the action database 118. For example, the corresponding action may be no action, extend payment plan, waive payment fees, remove late fees, send payment reminders a week before payment due date, send repayment plan options to the patron 134, contact the patron to discuss issues, etc. based on the patron 134 collection profile. The action module 110 executes, at step 510, the corresponding action extracted from the action database 118. For example, action module 110 may execute the action, such as extending the payment plan, waiving payment fees, removing late fees, sending payment reminders a week before the payment due date, sending repayment plan options to patron 134, contacting the patron to discuss issues, etc. through the property management software 128 or via the web portal 120 and notification system 126 of the property platform 102. If it is determined that there is no corresponding action or after the extracted action has been executed, the action module 110 determines, at step 512, if there are more patron profiles stored in the profile database 116. If it is determined that there are more patron profiles stored in the profile database 116, the action module 110 extracts, at step 514, the next patron profile from the profile database 116, and the process returns to comparing the patron profile to the action database 118. If it is determined that no more patron profiles are remaining in the profile database 116 the action module 110 returns, at step 516, to the base module 104.

FIG. 6 illustrates the feedback module 112. The process begins with the feedback module 112 being initiated by the base module 104. The feedback module 112 filters, at step 602, the account database 114 on patrons 134 with hardship payment plans. The feedback module 112 filters the account database 114 on the patrons who have opted in and are currently on hardship repayment plans. The feedback module 112 filters, at step 604, the account database 114 on patrons 134 in tier one of the hardship payment plan. The feedback module 112 further filters the account database 114 on the patrons 134 who are in tier 1 of the hardship payment plan, such as the patrons 134 who are experiencing property issues or disagreements with the property management 136. The feedback module 112 analyzes, at step 606, the payment history of patrons 134 in the tier. For example, the feedback module 112 may analyze the payment history by extracting the payment history data file of all the patrons 134 in the tier and determining if the payments are being repaid on time or if the payments are made late. The feedback module 112 may analyze the payment history to determine the percentage of payments made on time. For example, the analysis may be an algorithm that evaluates the patron's 134 accounts within the specific tier. The analysis may utilize variables from the account database 114, including the payment history data file which may include total payments and last payment date. It may iterate through the payment history records to calculate the aggregate sum of payments, accumulating in total payments. The analysis then compares the date of the last recorded payment with the current date to determine if it surpasses the agreed-upon payment interval. If the elapsed time exceeds said interval, the account is marked as potentially delinquent due to a recent payment lapse. Further, the analysis may compare the total payments against the amount owed for the corresponding period. Should the former fall short of the latter, indicating underpayment, the account is designated as delinquent. The analysis may flag or mark the account as delinquent and move on to the next account within the tier. The analysis then may determine the percentage of the accounts within the tier that are up to date on payments and the delinquent accounts. The feedback module 112 determines, at step 608, if the tier rule should be updated. For example, the feedback module 112 may utilize a threshold, such as 20%, to determine if the rue that is associated with the tier should be updated. If there are more than 20% of accounts that are still delinquent after having the payment plan adjusted based on the tier rules, then the feedback module 112 may determine that there are too many delinquent accounts that have been adjusted and that the rule and corresponding action need to be updated. If there are less than 20% of accounts that are considered delinquent, then the feedback module 112 may determine that the tier rule and associated action are effectively having patrons 134 pay through the adjusted payment plan, then the rule and associated action would not be updated. If it is determined that the tier rule should be updated, the feedback module 112 updates, at step 610, the rule and action associated with the tier. For example, the feedback module 112 may utilize an algorithm to dynamically update the rules based on payment trends. The algorithm may receive inputs including the percentage of accounts not meeting repayment obligations, current repayment rule parameters, defined hardship criteria, and historical payment data for each account. The algorithm may identify accounts experiencing late payments based on historical payment data against the predefined thresholds and evaluate the frequency and extent of late payments across all accounts. If the percentage of accounts failing to meet repayment obligations surpasses a predefined threshold or if late payments consistently deviate from the anticipated schedule, the algorithm proceeds to adjust the repayment rule parameters accordingly. For example, adjustments may include modifications to payment amounts, extension of payment deadlines, or provision of temporary relief measures for accounts facing hardship. Following the rule adjustments, the algorithm may continually monitor repayment statuses, periodically reassess the effectiveness of updated rules, and iteratively refine parameters based on feedback and evolving circumstances. The feedback module 112 stores, at step 612, the updated rule in the action database 118. The feedback module 112 may update the rule in the action database 118, such as extending the repayment length, reducing the amount owed, providing additional relief by delaying or deferring payments, etc. If it is determined that the tier rule should not be updated or after the updated tier rule is stored in the action database 118, the feedback module 112 determines, at step 614, if there are more tiers remaining in the account database 114. If it is determined that there are more tiers remaining in the account database 114, the feedback module 112 filters, at step 616, the account database 114 on patrons in the next tier, and the process returns to analyzing the payment history. If it is determined that there are no more tiers remaining in the account database 114, the feedback module 112 returns, at step 618, to the base module 104.

Table 1 below illustrates the account database 114. The account database 114 may be a database stored in the document repository 130 in which the patrons 134 data is collected through the property management software 128. The account database 114 may contain the patron's 134 information, such as the patron ID, first name, last name, address, home equity, the estimated value of the home, the patron's payment history stored as a data file, if the patron has hardship payments and the hardship tier the patron is in. In some embodiments, the account database 114 may contain the patron's 134 city, state, zip code, number of adults, number of children, education level, disposable income, liquid assets, income, patron's 134 middle initial, phone number, political party affiliation, if the patron 134 responds to emails, phone calls, or texts, the patron's 134 email address, social media avatars, social media profiles, such as LinkedIn, Facebook, Instagram, etc., if the patron 134 owns an RV, the number of vehicles, age, family size, years of employment, debt range, debt utilization, etc.

TABLE 1

| Patron ID | First Name | Last Name | Address | Home Equity | Estimated Value | Payment History | Hardship Payments | Hardship Tier |
|---|---|---|---|---|---|---|---|---|
| JD123 | John | Doe | 123 Main St | $200,000 | $300,000 | JD123payments data | No | N/A |
| JS321 | Jane | Smith | 456 Elm St | $150,000 | $250,000 | JS321payments.data | Yes | 1 |
| DJ789 | David | Johnson | 789 Oak St | $180,000 | $280,000 | DJ789payments.data | No | N/A |
| EB101 | Emily | Brown | 101 Pine St | $220,000 | $350,000 | EB101payments.data | Yes | 2 |
| — | — | — | — | — | — | — | — | — |
| — | — | — | — | — | — | — | — | — |
| — | — | — | — | — | — | — | — | — |

Table 2 below illustrates the profile database 116. The profile database 116 is created during the process described in the payment analysis module 106 and the profile module 108 in which the patron data stored in the account database 114 is stored, and the patron 134 opts-in to have a potential hardship situation reviewed and sends additional non-financial data which is also stored in the profile database 116. The profile database 116 may contain the patron's 134 ID, first name, last name, address, number of adults, number of children, education level, the potential hardship, such as financial, personal, legal, natural disaster, property issue, etc. In some embodiments, the profile database 116 may contain the patron's 134 rental history, employment history, timeliness of payments, remaining term on the payment plan, complaints, communication with property managers, renewal statuses, property condition, updating personal contact information, patron's 134 providing feedback, maintenance visits, damages or neglect of the property by the patron 134, parking violations, pet violations, etc. The profile database 116 may be used to compare the patron's 134 non-financial data, either previously collected and stored in the account database 114 or the newly received and stored data, to determine if the patron 134 is currently experiencing hardship and if the payment plan the patron 134 is currently on should be adjusted or not.

TABLE 2

| Patron | First | Last | | # of | # of | | Hardship | | | | |
|---|---|---|---|---|---|---|---|---|---|---|---|
| ID | Name | Name | Address | Adults | Children | Education | Financial | Personal | Legal | Natural | Property |
| JS321 | Jane | Smith | 456 Elm St | 2 | 1 | PhD | No | No | No | No | Yes |
| EB101 | Emily | Brown | 101 Pine St | 1 | 0 | Masters | No | Yes | No | No | No |
| TJ852 | Thomas | Johnson | 654 Maple Rd | 2 | 2 | Bachelors | Yes | No | No | No | No |
| — | — | — | — | — | — | — | — | — | — | — | — |
| — | — | — | — | — | — | — | — | — | — | — | — |
| — | — | — | — | — | — | — | — | — | — | — | — |

Table 3 below illustrates the action database 118. The action database 118 may be a previously created or existing database that contains a plurality of rules that are used in the action module 110 to determine if there is a corresponding action or notification that needs to be sent to a patron 134. The action database 118 may contain a hardship tier, the type of hardship, the rule, and the corresponding action. In some embodiments, the rules may be generic rules based on the total profile of the patron's 134 collection profile. In some embodiments, the rules may be based on the tier and type of hardship that the patron 134 is experiencing, or there may be multiple types of hardship situations in multiple different tiers. In some embodiments, the rules may ease the collection of payments made by the patron 134 to provide financial flexibility depending on the patron's 134 current situation. In some embodiments, the corresponding actions may range from extending the payment plan to waiving the payments required by the patron 134. For example, if patron 134 is facing financial hardship, such as loss of employment, the corresponding action may be to offer temporary payment deferrals, waiving of certain fees, or reduced payment plans until the member secures new employment. If patron 134 is experiencing difficulties from a natural disaster, such as flooding, the corresponding action may be to offer temporary relief by allowing affected members to delay payments or reduce payment amounts temporarily while they repair their property. If the patron is experiencing a serious illness, such as terminal cancer, then the corresponding action may waive the remaining payments of the patron 134. If patron 134 is facing legal issues, such as a lawsuit settlement, the corresponding action may be to arrange a payment plan tailored to the patron's 134 financial situation after a lawsuit settlement to ensure they can fulfill their HOA obligations. If patron 134 is experiencing property issues, such as plumbing issues, the corresponding action may be for the property management software 128 to contact maintenance to address the plumbing issue and remove the late fees from patron's 134 account.

TABLE 3

| Tier | Hardship | Rule | Action |
|---|---|---|---|
| 1 | Property | Property has Plumbing Issues | Contact Maintenance and Remove |
| | | | Late Fees |
| 1 | Property | Property has Roofing Problems | Extend Payment Plan for 4 Months |
| | | | and Reduce Payments |
| — | — | — | — |
| 2 | Financial | If Person Recently Lost Employment | Extend Payment Plan Out an |
| | | | Additional 3 Months |
| 2 | Financial | If Person Recently Has Unexpected | Lower Monthly Payments and Extend |
| | | Medical Expenses | Plan for Additional 4 Months |
| — | — | — | — |
| 3 | Personal | If Person is Facing Terminal Illness | Waive the Remaining Payment Fees |
| — | — | — | — |
| 4 | Legal | Person Obligated to Pay | Extend Payments for an |
| | | Settlement in Lawsuit | Additional 6 Months |
| — | — | — | — |
| 5 | Natural | Property was Damaged From Flooding | Waive Late Fees and Extend Payment |
| | | | Plan Out an Additional 9 Months |
| — | — | — | — |
| — | — | — | — |
| — | — | — | — |

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A method for determining collection path, the method comprising:
storing a plurality of tiers each associated with a type of hardship event and one or more rules;
receiving data associated with a user account over a communication network;
extracting one or more features from the received data, wherein the features are associated with threshold conditions;
analyzing the features using a machine learning model to determine likelihood of a payment event associated with the user account and a tier associated with the user account, wherein analyzing the features includes determining that a hardship event has occurred based on the data associated with the user account; and
executing an action based on the tier associated with the user account.

2. The method of claim 1, wherein analyzing the features includes extracting non-financial data from the received data to determine that the hardship event has occurred consistent with the tier associated with the type of hardship.

3. The method of claim 1, further comprising training the machine learning model based on historical data relating to a plurality of features and patterns of payment events.

4. The method of claim 3, further comprising updating the trained machine learning model to remove outliers.

5. The method of claim 3, further comprising updating the trained machine learning model based on updates to the historical data.

6. The method of claim 3, further comprising updating the trained machine learning model automatically based on one or more thresholds for feature drift.

7. The method of claim 1, wherein analyzing the features using the machine learning to further determine a timeline of the payment event occurring.

8. The method of claim 1, further comprising communicating with one or more third party networks to receive the data of the user account.

9. The method of claim 1, further comprising dynamically updating the rules associated with a tier based on a percentage of delinquent user accounts in the tier exceeding a threshold value.

10. The method of claim 1, further comprising dynamically updating the rules associated with a tier based on payment trends of the user account.

11. A system for determining collection path, the system comprising:
memory that stores a plurality of tiers each associated with a type of hardship event and one or more rules;
a communication interface that communicates over a communication network to receive data associated with a user account; and
a processor that executes instructions stored in memory, wherein the processor executes the instructions to:
extract one or more features from the received data, wherein the features are associated with threshold conditions;
analyze the features using a machine learning model to determine likelihood of a payment event associated with the user account and a tier associated with the user account, wherein analyzing the features includes determining that a hardship event has occurred based on the data associated with the user account; and
executing an action based on the tier associated with the user account.

12. The system of claim 11, wherein the processor analyzes the features by extracting non-financial data from the received data to determine that the hardship event has occurred consistent with the tier associated with the type of hardship.

13. The system of claim 11, wherein the processor executes further instruction to train the machine learning model based on historical data relating to a plurality of features and patterns of payment events.

14. The system of claim 13, wherein the processor executes further instruction to update the trained machine learning model to remove outliers.

15. The system of claim 13, wherein the processor executes further instruction to update the trained machine learning model based on updates to the historical data.

16. The system of claim 13, wherein the processor executes further instruction to update the trained machine learning model automatically based on one or more thresholds for feature drift.

17. The system of claim 11, wherein the processor analyzes the features using the machine learning to further determine a timeline of the payment event occurring.

18. The system of claim 11, wherein the communication interface communicates with one or more third party networks to receive the data of the user account.

19. The system of claim 11, wherein the processor executes further instruction to dynamically update the rules associated with a tier based on payment trends of the user account.

20. A non-transitory, computer-readable storage medium, having embodied thereon a program executable by a processor to perform a method for determining collection path, the method comprising:
storing a plurality of tiers each associated with a type of hardship event and one or more rules;
receiving data associated with a user account over a communication network;
extracting one or more features from the received data, wherein the features are associated with threshold conditions;
analyzing the features using a machine learning model to determine likelihood of a payment event associated with the user account and a tier associated with the user account, wherein analyzing the features includes determining that a hardship event has occurred based on the data associated with the user account; and
executing an action based on the tier associated with the user account.
